(19) United States
(12) Patent Application Publication
(10) Pub. No.: US 2013/0160381 A1
(43) Pub. Date: Jun. 27, 2013

(54) REMOTE PET LITTER BOX ENCLOSURE

(71) Applicant: Barbara Sommer, Irving, TX (US)

(72) Inventor: Barbara Sommer, Irving, TX (US)

(73) Assignee: NATCAT COMPANY, Carrollton, TX (US)

(21) Appl. No.: 13/335,923

(22) Filed: Dec. 22, 2011

(51) Int. Cl. A01K 29/00; E04H 14/00; A47B 83/00

(52) U.S. Cl. 52/173.1; 119/165; 312/237

(57) ABSTRACT

In one embodiment, a remote pet litter box enclosure has a cabinet, box or other enclosure containing a pet litter box or other pet waste disposal device, which can be accessed by a pet through a tunnel or hole, the entry and exit point of which originates in another room within a home or dwelling.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

The present invention generally pertains to furniture. More particularly, the present invention pertains to indoor furniture cabinets that enclose pet litter boxes and/or other pet waste disposal devices.

Domestic companion animals, or “pets,” such as cats and dogs, are popular throughout the United States and the world. But pets can also present problems within a home or dwelling, including health risks to children, pregnant women, and those suffering from certain allergies. Pets also generate waste. Conventional pet litter boxes or other pet waste disposal devices are generally placed on the floor of a utility room or in another inconspicuous place in a home or dwelling. In order to be of use, however, the pet must have ready access to the location of the pet litter box or other pet waste disposal device.

Locating a pet waste disposal device inside a home or dwelling presents many problems, including but not limited to litter dust within the home, tracking of litter throughout the home or dwelling, unpleasant odors, and unsanitary conditions. Moreover, it is often difficult to store pet litter or other accessories related to pet litter boxes or other pet waste disposal devices in a location that is near the pet waste disposal device while maintaining sanitary conditions and a neat and orderly appearance. While some pet litter boxes include a lid or box-like form, these approaches do not avoid many of the problems associated with conventional pet litter boxes or other pet waste disposal devices.

### SUMMARY OF THE INVENTION

In one embodiment, a remote pet litter box enclosure includes an interior that humans can access through one or more doors, drawers and/or lids, and which can contain one or more pet litter boxes or other pet waste disposal devices. The remote pet litter box enclosure also includes an access aperture, such as a tunnel or hole, through which a pet can enter and exit the remote pet litter box enclosure in order to use the pet litter box or other pet waste disposal device. The access aperture can include an entry point located a predetermined distance from the remote pet litter box enclosure interior. The remote pet litter box enclosure can be configured so that the access aperture entry point and remote pet litter box enclosure interior are located in different rooms.

### BRIEF DESCRIPTION OF THE DRAWING

FIG. 1 illustrates a remote pet litter box enclosure in operation, in accordance with one embodiment.

FIG. 2 illustrates a remote pet litter box enclosure in operation, in accordance with one embodiment, showing a remote pet litter box in relation to an interior building wall.

FIG. 3 illustrates a side view of a remote pet litter box enclosure in operation, in accordance with one embodiment, showing a remote pet litter box in relation to an interior building wall.

FIG. 4 is a front view of a remote pet litter box enclosure in accordance with one embodiment.

FIG. 5 is a left side view of a remote pet litter box enclosure in accordance with one embodiment.

FIG. 6 is a rear view (without a back) of a remote pet litter box enclosure in accordance with one embodiment.

FIG. 7 is a perspective view of a remote pet litter box enclosure in accordance with one embodiment.

FIG. 8 is a perspective view of a remote pet litter box enclosure in accordance with one embodiment, with enclosure doors shown in an open position.

FIG. 9 is a perspective view of a remote pet litter box enclosure in accordance with one embodiment, with enclosure doors shown in an open position, and a tray shelf shown in an open position.

FIG. 10 is a perspective view of a remote pet litter box enclosure in accordance with one embodiment, with enclosure doors shown in an open position, a tray shelf shown in an open position, and without a pet litter box or pet ramp.

FIG. 11 is a rear perspective view of a remote pet litter box enclosure in accordance with one embodiment, with enclosure doors shown in an open position, and showing use of tunnel entry access aperture.

FIG. 12 is a right side view of a remote pet litter box enclosure in accordance with one embodiment, with the right side panel omitted.

FIG. 13 is a front view of a remote pet litter box enclosure in accordance with one embodiment, with the addition of upper storage cabinets.

FIG. 14 is a left side view of a remote pet litter box enclosure of the present invention, with the addition of upper storage cabinets.

FIG. 15 is a perspective view of a remote pet litter box enclosure in accordance with one embodiment, with the addition of upper storage cabinets.

FIG. 16 is a perspective view of a remote pet litter box enclosure in accordance with one embodiment, with the addition of an upper hutch.

FIG. 17 is a perspective view of a pet access tunnel to be contained within a remote pet litter box enclosure in accordance with one embodiment, with flaps in the closed position.

FIG. 18 is a perspective view of a pet access tunnel to be contained within a remote pet litter box enclosure in accordance with one embodiment, with flaps in the rear-facing position.

FIG. 19 is a perspective view of a pet access tunnel to be contained within a remote pet litter box enclosure in accordance with one embodiment, with flaps in the forward-facing position.

FIG. 20 is a front view of a pet access tunnel to be contained within a remote pet litter box enclosure in accordance with one embodiment, with flaps in the closed position.

FIG. 21 is a side view of a pet access tunnel to be contained within a remote pet litter box enclosure in accordance with one embodiment, with flaps in the closed position.

FIG. 22 is a side view of a pet access tunnel to be contained within a remote pet litter box enclosure in accordance with one embodiment, with flaps in the rear-facing position.

FIG. 23 is a right side view of a pet ramp contained within a remote pet litter box enclosure in accordance with one embodiment.

FIG. 24 is a front view of a pet ramp contained within a remote pet litter box enclosure in accordance with one embodiment.

FIG. 25 is a top view of a pet ramp contained within a remote pet litter box enclosure in accordance with one embodiment.

FIG. 26 is a perspective view of a pet ramp contained within a remote pet litter box enclosure in accordance with one embodiment.

FIG. 27 is a right side view of a pet ramp contained within a remote pet litter box enclosure in accordance with one embodiment.

FIG. 28 is a perspective view of a pet ramp contained within a remote pet litter box enclosure in accordance with one embodiment.

FIG. 29 is a side view of a pet litter box to be contained within a remote pet litter box enclosure in accordance with one embodiment.

FIG. 30 is a top view of a pet litter box to be contained within a remote pet litter box enclosure in accordance with one embodiment.

FIG. 31 is a perspective view of a pet litter box to be contained within a remote pet litter box enclosure in accordance with one embodiment.

FIG. 32 is a perspective view of a pet litter box to be contained within a remote pet litter box enclosure in accordance with one embodiment, with an access notch contained on one side.

FIG. 33 is a front view of a pet waste accessory tray to be contained within a remote pet litter box enclosure in accordance with one embodiment.

FIG. 34 is a rear view of a pet waste accessory tray to be contained within a remote pet litter box enclosure in accordance with one embodiment.

FIG. 35 is a left side view of a pet waste accessory tray to be contained within a remote pet litter box enclosure in accordance with one embodiment.

FIG. 36 is a right side view of a pet waste accessory tray to be contained within a remote pet litter box enclosure in accordance with one embodiment.

FIG. 37 is a top view of a pet waste accessory tray to be contained within a remote pet litter box enclosure in accordance with one embodiment.

FIG. 38 is a perspective view of a pet waste accessory tray to be contained within a remote pet litter box enclosure in accordance with one embodiment.

FIG. 39 is a front view of a remote pet litter box enclosure in accordance with one embodiment, having a top lid and pet access tunnel mounted on the side.

FIG. 40 is a side view of a remote pet litter box enclosure in accordance with one embodiment, having a top lid.

FIG. 41 is a perspective view of a remote pet litter box enclosure in accordance with one embodiment, having a top lid and pet access tunnel mounted on the side, with the front surface omitted to show a view of the interior.

FIG. 42 is a perspective view of a remote pet litter box enclosure in accordance with one embodiment, having a top lid and pet access tunnel mounted in the rear, with the front surface omitted to show a view of the interior.

FIG. 43 is a perspective view of a remote pet litter box enclosure in accordance with one embodiment, having a top lid and pet access tunnel mounted in the rear, with the rear surface omitted to show a view of the interior.

### DETAILED DESCRIPTION OF THE INVENTION

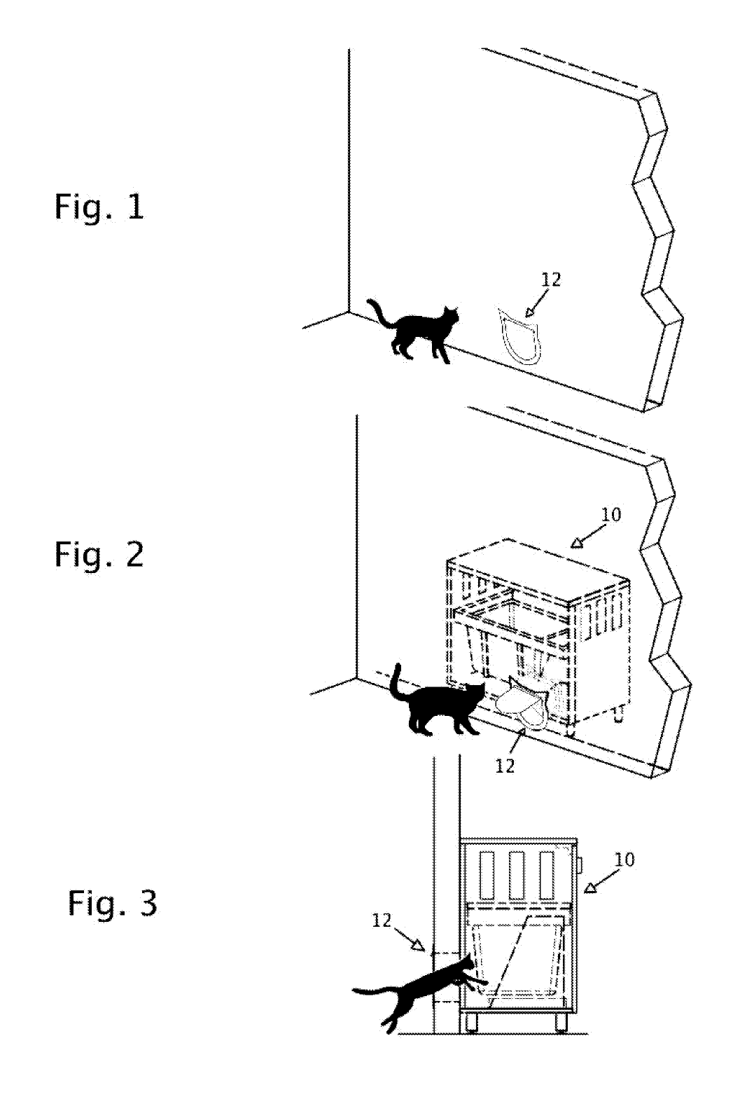

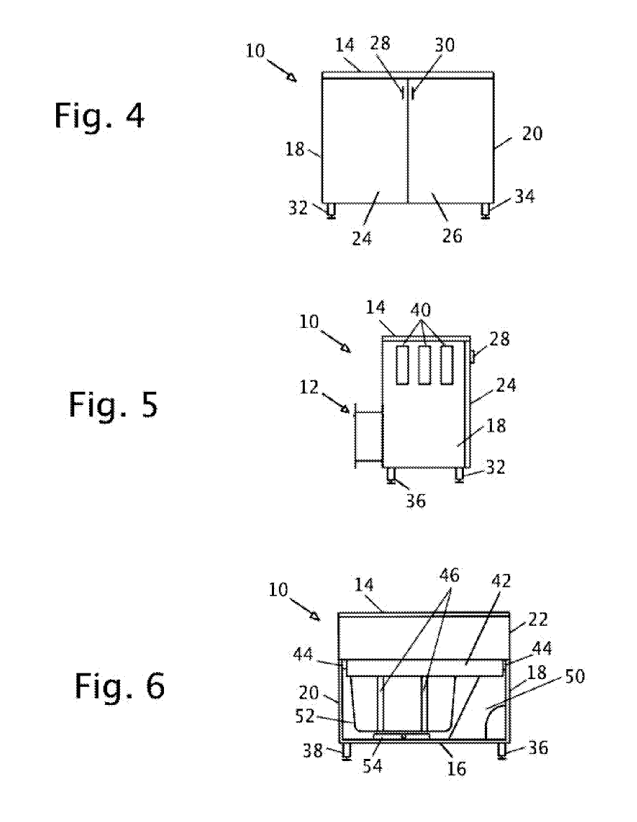

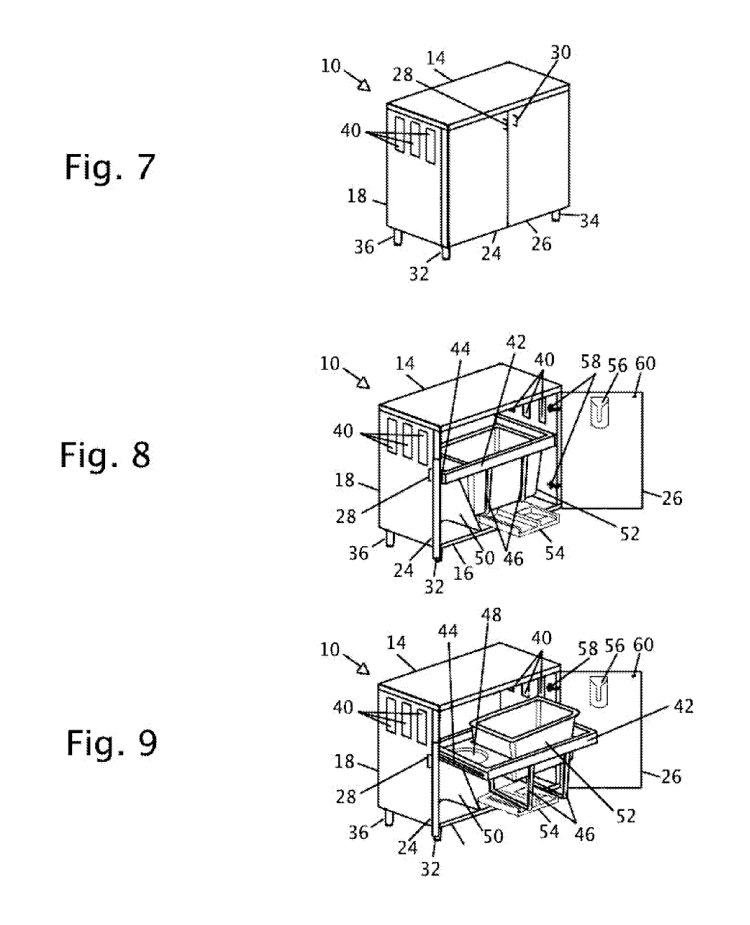

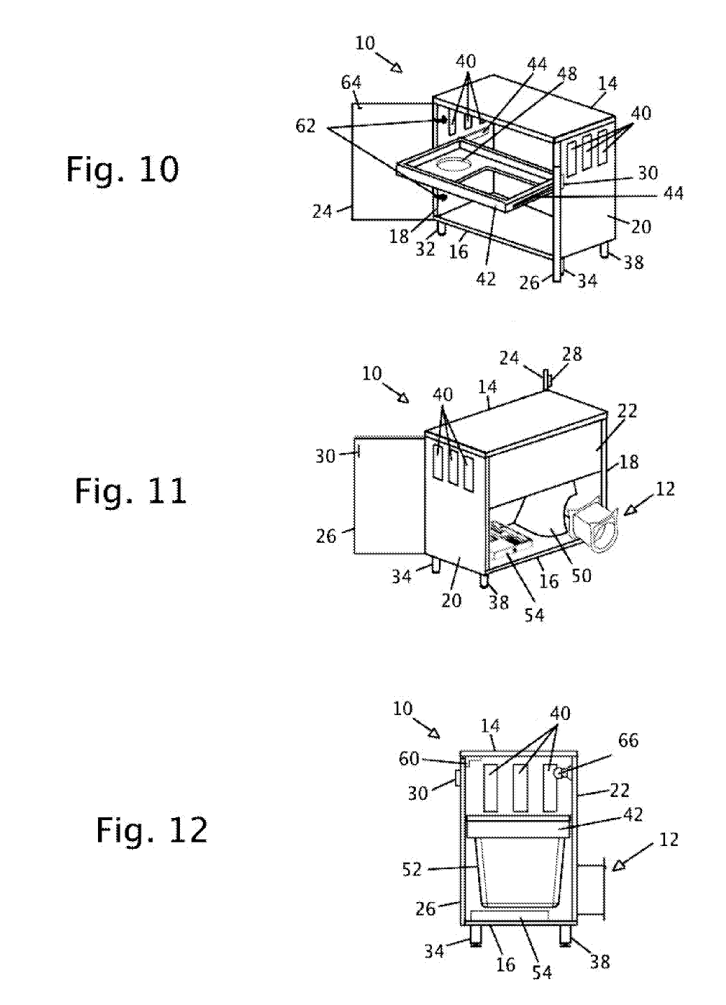

Referring to the drawing in more detail, FIGS. 1 through 12 show a remote pet waste enclosure in accordance with one embodiment. FIGS. 1 through 3 show a remote pet waste enclosure 10 situated in one room, with an aperture 12 configured to allow access, through a wall, to the interior of the remote pet waste enclosure. FIGS. 4 through 12 show a remote pet waste enclosure in additional detail.

More particularly, FIGS. 4 through 9 show a remote pet waste enclosure 10 having a top 14, a bottom 16, a left side 18, a right side 20, a back 22, and a front comprising a left enclosure door 24 and a right enclosure door 26. Left enclosure door 24 includes a left handle 28 and right enclosure door 26 includes a right handle 30. In the illustrated embodiment, remote pet waste enclosure 10 is supported by a left front leg 32, a right front leg 33, a left rear leg 36, and a right rear leg 38, each located at the approximate corners of bottom 16.

Left side 18 and the right side 20 include ventilation points 40. An aperture 12 is located on the back 20. In the illustrated embodiment, aperture 12 includes a tunnel, as described in more detail below. As shown, top 14, bottom 16, left side 18, right side 20, back 22, left enclosure door 24, and right enclosure door 26 define an enclosure. As described in more detail below, the enclosure contains additional feature.

For example, inside the enclosure is a litter box shelf 42, which is mounted on sliding brackets 44. Litter box shelf 42 includes litter box supports 46 and a pet access hole 48. Also inside the enclosure is a pet ramp 50 that leads to pet access hole 48 when litter box shelf 42 is in a back position. Inside litter box shelf 42, and supported by litter box supports 46, is a pet litter box 52.

An accessory tray 54 mounts to bottom 16 and is capable of sliding forwards and backwards. On left enclosure door 22 is mounted an accessory hook 56, left enclosure door hinges 58 and a left enclosure door clasp 60. On the right enclosure door 24 is mounted right enclosure door hinges 62 and a right enclosure door clasp 64. Inside the enclosure is mounted a light 66.

Generally, remote pet waste enclosure 10 as shown in FIGS. 1 through 12 is constructed so that pet litter box 52 is supported by litter box supports 46 and fits within a hole in litter box shelf 42. When left enclosure door 24 and right enclosure door 26 are opened, litter box shelf 42 can be pulled forward on sliding brackets 44 to allow for cleaning of the pet litter and removal of the pet litter box 52. When litter box shelf 42 is in the back position, a pet can use the litter box, travel through pet access hole 48, down pet ramp 50, and out of remote pet waste enclosure 10 through aperture 12. Generally, in one embodiment, remote pet waste enclosure 10 is configured so that the aperture 12 connects remote pet waste enclosure 10 to a separate room. So configured, remote pet waste enclosure 10 can be situated in a convenient room in a building (such as a house or dwelling, for example) while allowing pet access from another room in the building.

In one embodiment, remote pet waste enclosure 10 is configured to contain a pet litter box 52 or other pet waste disposal device, as well as contain an area for movement by a pet within the remote pet litter box enclosure 10 without being in the pet litter box 52. In one embodiment, remote pet waste enclosure 10 is approximately 36 to 48 inches wide, approximately 14 to 26 inches deep, and approximately 30 to 42 inches tall. In one embodiment, remote pet waste enclosure 10 is also configured to provide for a pet access tunnel 12 that is sufficiently wide and tall, such as approximately 4 to 18 inches, to allow for ingress and egress by a pet, and sufficiently long, such as approximately 5 to 36 inches, to connect remote pet waste enclosure 10 to another room in the building.

Remote pet waste enclosure 10, along with other elements herein described, may be made of wood, particle board, plastic, or any other sufficient rigid and strong material. Further, the various components of the remote pet litter box enclosure 10 can be made of different materials. Further, the ventilation points 40 may be holes, vents, filtered air ducts, or other method of providing adequate ventilation.

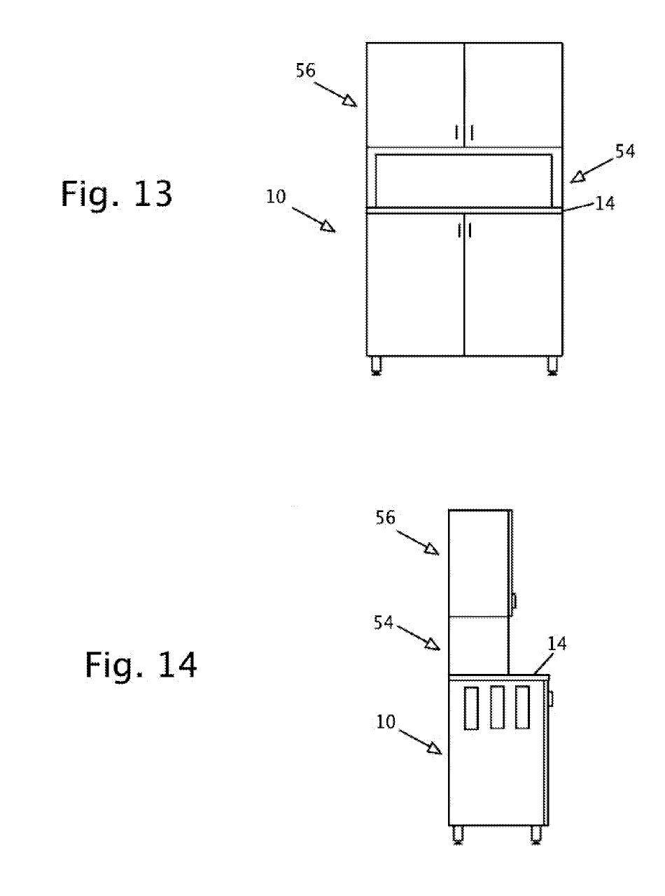

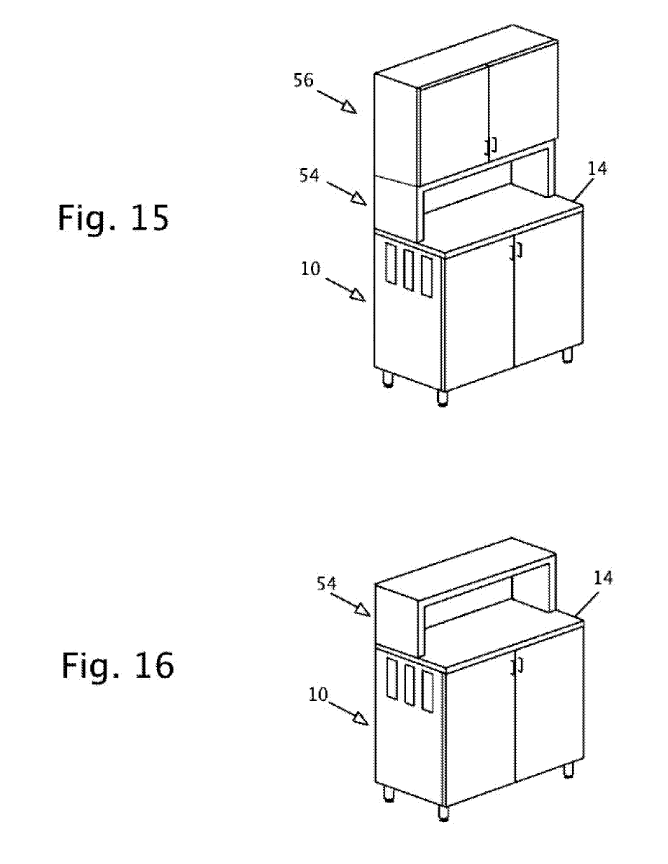

FIGS. 13 through 16 show a remote pet waste enclosure 10 configured with a shelf 54 and a hutch 56 coupled to top 14. One skilled in the art will understand that shelf 54 and/or hutch 56 can be configured in a variety of ways, and constructed from a variety of suitable materials.

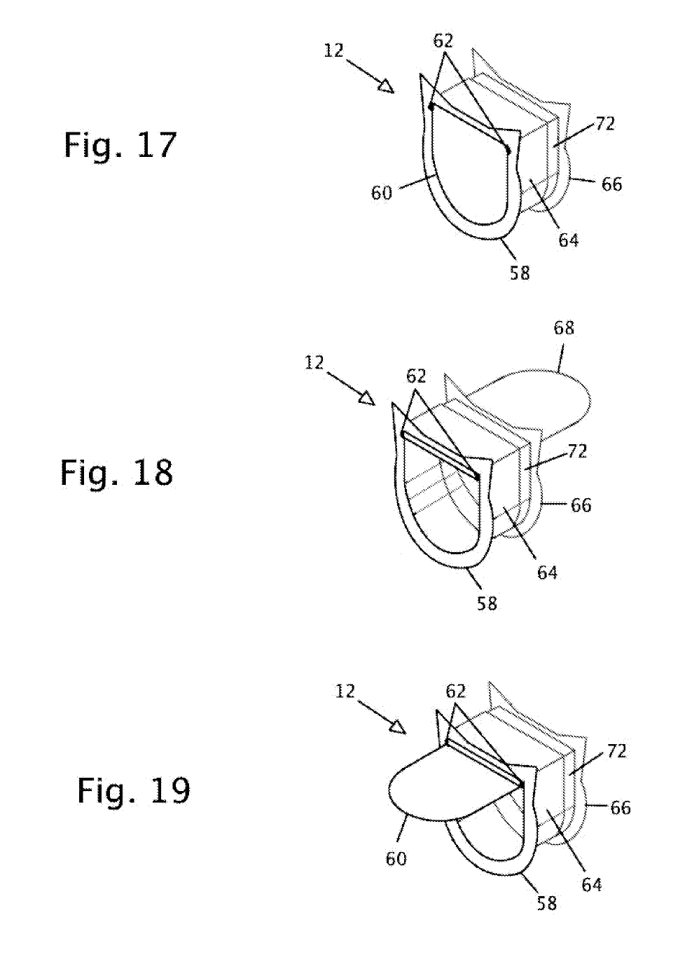

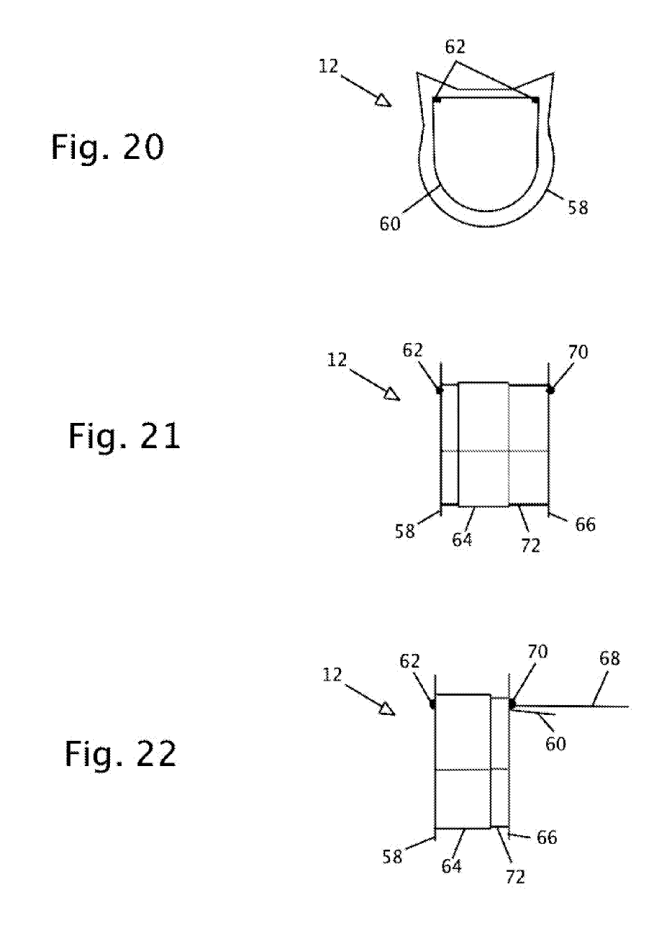

FIGS. 17 through 22 show an aperture 12 configured as a tunnel, in accordance with one embodiment. Generally, aperture 12 includes front face 58, a front face door 60, front face hinges 62, a front face tunnel section 64, back face 66, a back face door 68, back face hinges 70, and a back face tunnel section 72.

Generally, in the illustrated embodiment, aperture 12 as shown is configured to allow the front face 58 to rest flush on the surface of an interior wall of a building, with the front face tunnel section 64 to be inserted in a hole in the interior wall, while the back face rests flush on the surface of the other side of that same wall, with the back face tunnel section 72 inserting into the front face tunnel section 64 to form a complete tunnel. The front face door 60 is mounted to the front face 58 by the front face hinges 62, and the back face door 68 is mounted to the back face 66 by the back face hinges 70, so that the front face door 60 and the back face door 68 can swing freely.

Generally, aperture 12 is configured sufficiently wide and tall, such as approximately 4 to 18 inches, to allow for ingress and egress by a pet, and sufficiently long, such as approximately 4 to 36 inches, to connect a remote pet waste enclosure 10 with another room in the building. Further, in the illustrated embodiment, the bottom portion of aperture 12 is shown is curved in shape to discourage certain pets, such as dogs, from entering aperture 12, while encouraging other pets, such as cats, to enter. Generally, aperture 12 may be made of plastic or any other sufficient rigid and strong material. Further, the various components of the aperture 12 can be made of different materials.

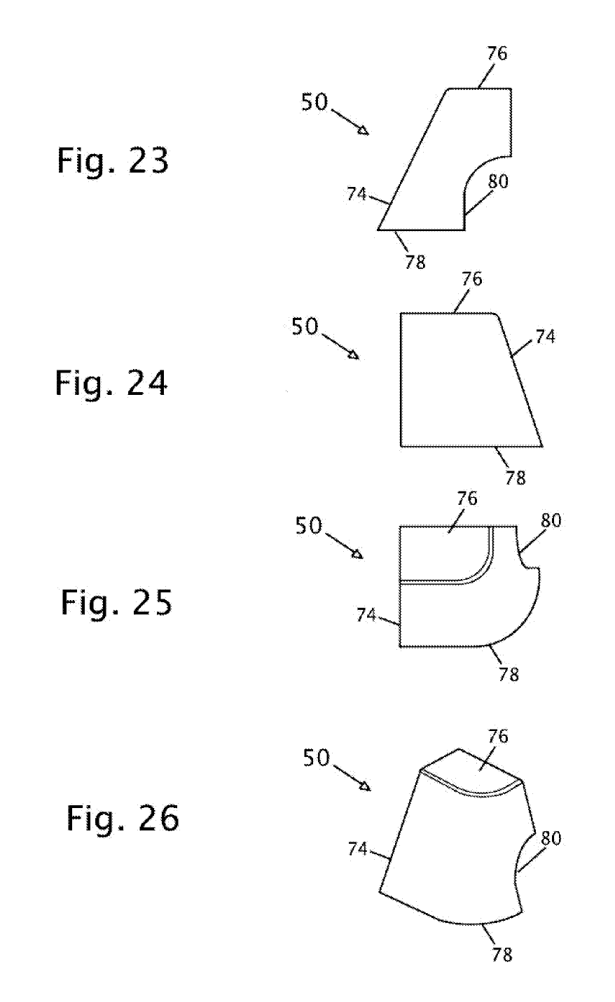

FIGS. 23 though 28 show a pet ramp 50 in accordance with one embodiment. As shown, pet ramp 50 includes an angled ramp surface 74, a ramp top 76, a ramp base 78, and a ramp cut out 80.

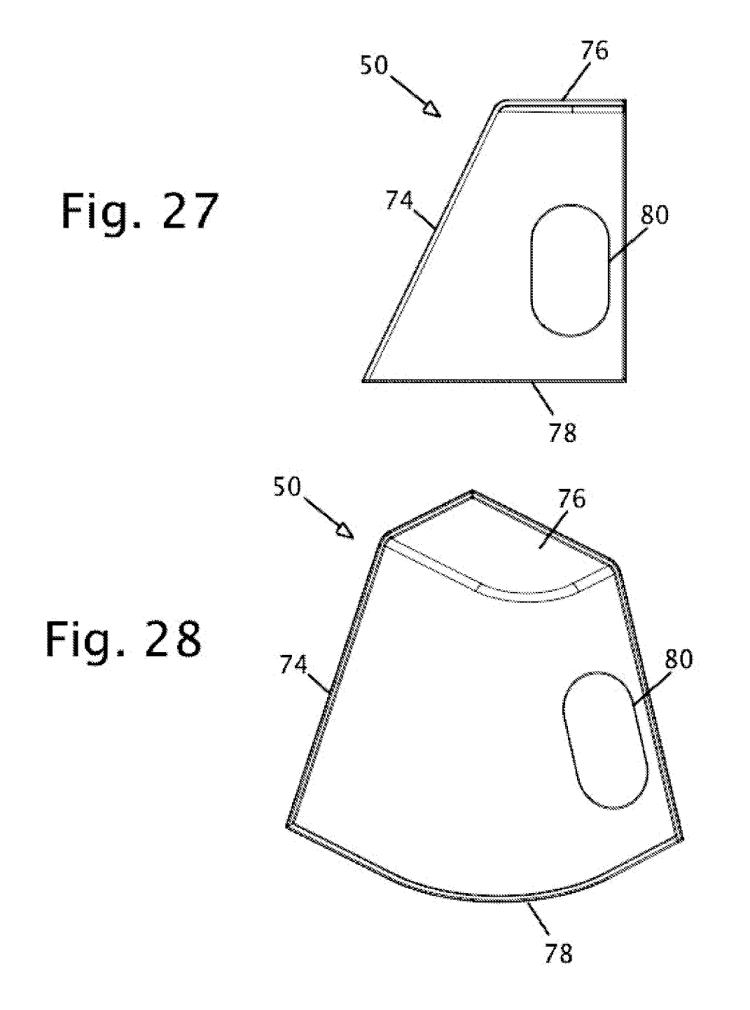

Generally, pet ramp 50 as shown is constructed with a ramp cut out 80, to allow the back face door 68 of the aperture 12 (not shown in FIGS. 23 through 28), to swing freely, and with an angled ramp surface 74 to allow a pet to climb or walk to the ramp top 76, allowing a pet to gain access to the elevated pet litter box 52. In one embodiment, ramp base 78 rests on the bottom 16 of a remote pet waste enclosure 10 (not shown in FIGS. 23 through 28), and is generally located near aperture 12 on the opposite side of the remote pet litter box enclosure 10 from the pet litter box 52.

In one embodiment, pet ramp 50 is sufficiently tall, such as approximately 6 to 18 inches, and the ramp top 76 is sufficiently small, such as approximately 4 to 8 inches, to allow for a pet to comfortably reach and enter the pet access hole 48 contained in the litter box shelf 42 (not shown in FIGS. 23 through 28). The ramp base 78 is sufficiently wide and deep, such as approximately 8 to 20 inches, to provide stability to the pet ramp 50, and as shown is curved in shape to allow a pet easy access to the ramp top 76.

Generally, pet ramp 50 may be made of plastic or any other sufficient rigid and strong material. Further, angled ramp surface 74 may be covered in carpet or any other material or substance that will help remove pet litter from a pet's paws and otherwise prevent pet litter and pet litter dust from leaving the remote pet waste enclosure 10 (not shown in FIGS. 23 through 28). Further, the various components of pet ramp 50 can be made of different materials.

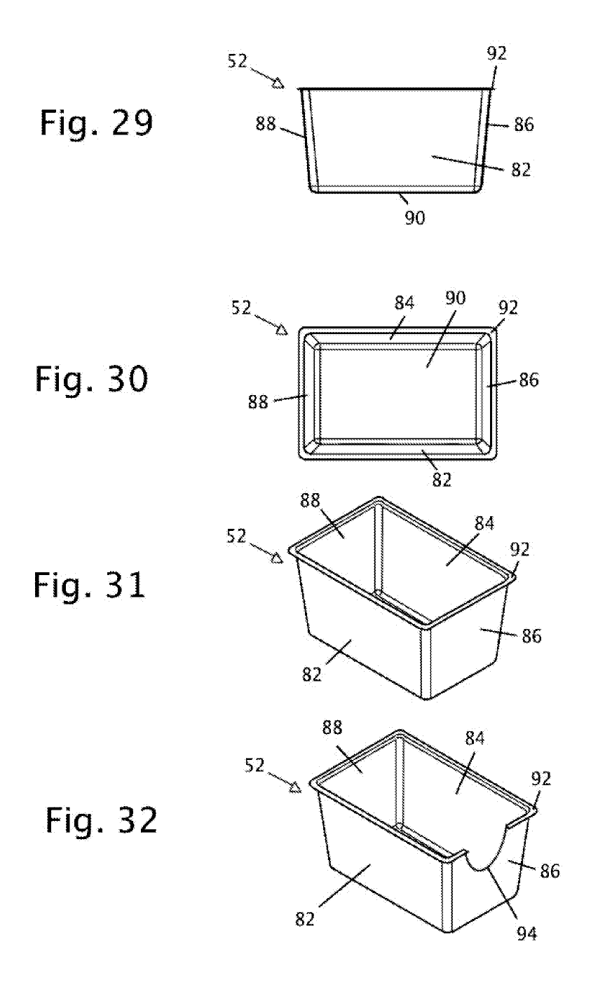

FIGS. 29 through 32 show a pet litter box 52 having a box front side 82, a box back side 84, a box right side 86, a box left side 88, a box bottom 90, a box lip 92, and a box cut out 94. Generally, pet litter box 52 as shown is constructed with a box lip 92, to allow the pet litter box 52 to fit within and cover the corresponding hole in litter box shelf 42 (not shown in FIGS. 29 through 32). The pet litter box 52 as shown in FIG. 32 includes a box cut out 94 to allow a pet ease of access to the interior of the pet litter box 52.

Generally, in one embodiment, pet litter box 52 is sufficiently wide, such as approximately 6 to 24 inches, and sufficiently long, such as approximately 12 to 30 inches, and sufficiently deep, such as approximately 4 to 18 inches, to allow for the inclusion of a sufficient amount of pet litter. Generally, pet litter box 52 may be made of plastic or any other sufficient rigid and strong material. Further, the various components of the pet litter box 52 can be made of different materials.

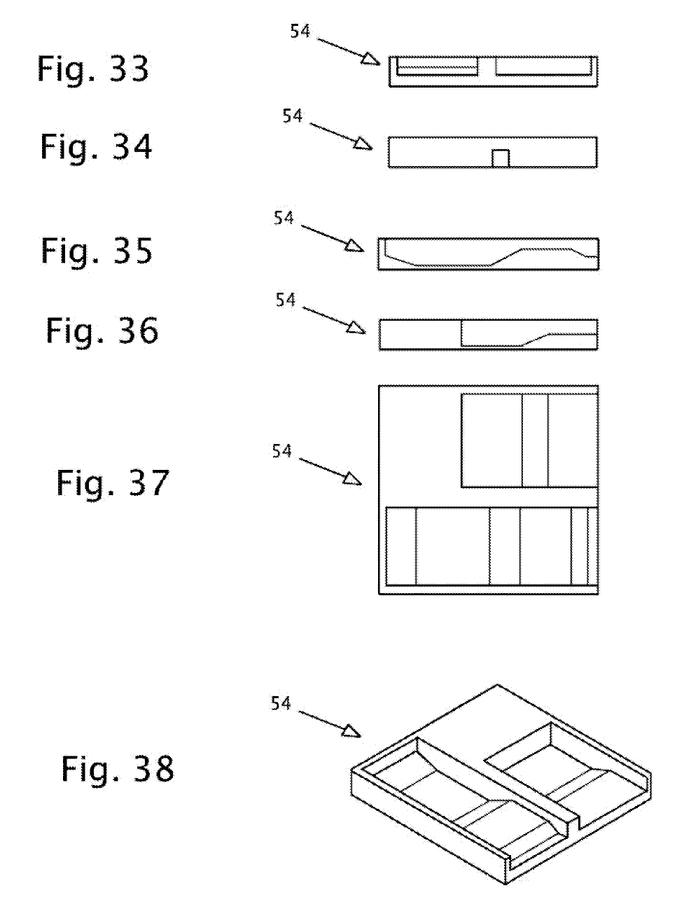

FIGS. 33 through 38 show an accessory tray 54, in accordance with one embodiment. Generally, accessory tray 54 as shown is constructed in a molded form for the convenient storage of pet litter accessories, and rests on the bottom 14 of the remote pet waste enclosure 10 (not shown in FIGS. 33 through 38). In one embodiment, accessory tray 54 is sufficiently wide, such as approximately 10 to 17 inches, and sufficiently long, such as approximately 12 to 20 inches, and sufficiently tall, such as approximately 2 to 4 inches, to allow for the storage of a pet litter scoop and pet litter brush, or other pet litter or pet waste disposal accessories. Generally, accessory tray 54 may be made of plastic or any other sufficient rigid and strong material. Further, the various components of accessory tray 54 can be made of different materials.

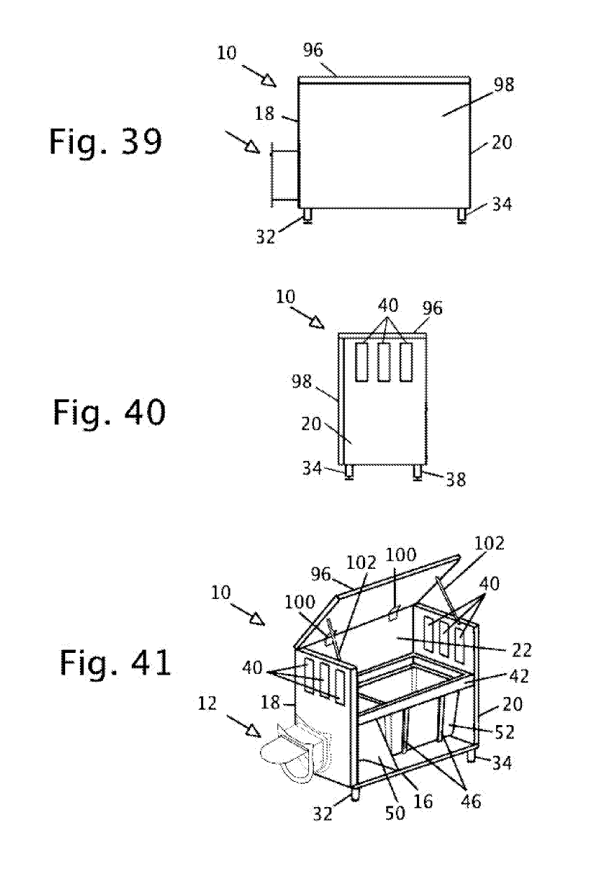

FIGS. 39 through 41 show a remote pet waste enclosure 10, configured with a top lid 96 that can be opened to allow access to the interior of remote pet waste enclosure 10. More particularly, in the illustrated embodiment, remote pet waste enclosure 10 includes having a top lid 96, a bottom 16, a left side 18, a right side 20, and front 98, and a back 22. Remote pet waste enclosure 10 is supported by a left front leg 32, right front leg 34, a left rear leg (not shown) and a right rear leg 38, each located at the approximate corners of the bottom 14. The left side 18 and the right side 20 include ventilation points 40. An aperture 12 is coupled to left side 18. Inside the enclosure is a litter box shelf 42, which is mounted to left side 18 and right side 20. Also inside the enclosure is a pet ramp 50, which leads to the pet access hole 48 in the litter box shelf 42. Inside the litter box shelf 42, and supported by the litter box supports 46, is a pet litter box 52. On the top lid 96 is mounted a lid hinge 100.

Generally, the remote pet waste enclosure 10 as shown is constructed so that pet litter box 52 is supported by the litter box supports 46 and fits within a hole in the litter box shelf 42. When the top lid 96 is opened, the litter box shelf 42 and the pet litter box 52 can be accessed. A pet can use the litter box, travel through the pet access hole 48, down the pet ramp 50 and out of the remote pet litter box enclosure 106 by way of the pet access tunnel 40 and return to the building.

Generally, in one embodiment, remote pet waste enclosure 10 is sufficiently wide, such as approximately 36 to 48 inches, deep, such as approximately 14 to 26 inches, and tall, such as approximately 30 to 42 inches, to contain a pet litter box 52 or other pet waste disposal device, as well as contain an area for movement by a pet within the remote pet waste enclosure 10 without being in the pet litter box 52. The remote pet waste enclosure 10 is also sufficient to provide for an aperture 12 that is sufficiently wide and tall, such as approximately 4 to 18 inches, to allow for ingress and egress by a pet, and sufficiently long, such as approximately 5 to 36 inches, to connect the remote pet waste enclosure 10 and another room in the building in which remote pet waste enclosure 10 is situated.

Generally, remote pet waste enclosure 10, along with other elements herein described, may be made of wood, particle board, plastic or any other sufficient rigid and strong material. Further, the various components of the remote pet waste enclosure 10 can be made of different materials. Further, the ventilation points 40 may be holes, vents, filtered air ducts, or other method of providing adequate ventilation.

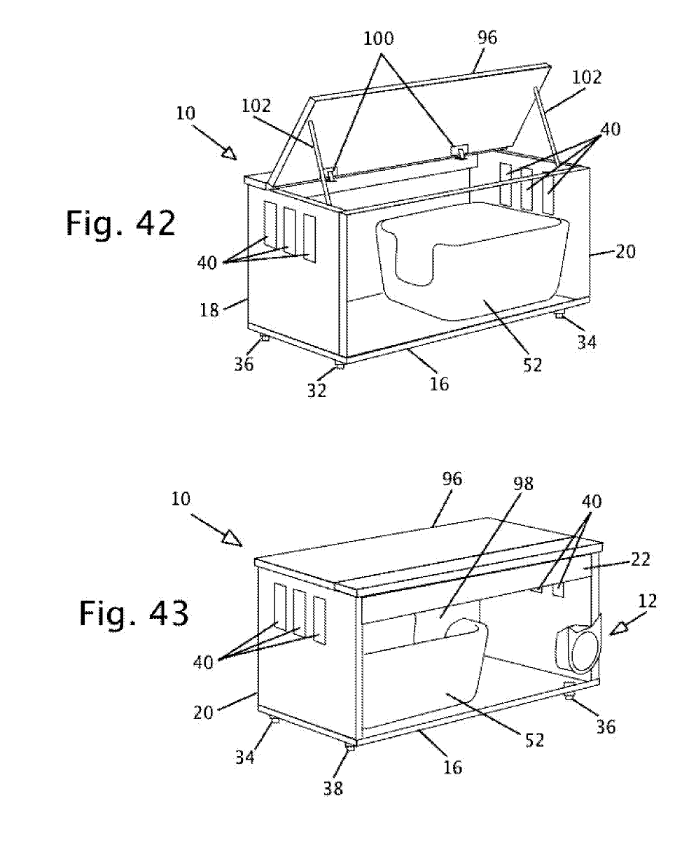

FIGS. 42 and 43 show a remote pet waste enclosure 10, configured with a top lid 96, and an aperture 12 located on a back 22. Generally, the embodiment shown in FIGS. 42 and 43 can be otherwise configured as described above with respect to FIGS. 39 through 41.

The embodiments described herein provide numerous technical advantages. For example, the advantages in accordance with one embodiment include, without limitation, that the location of the primary pet litter box or pet waste disposal system is placed in a garage or remote location while allowing access by the pet from a different location, which allows for the unpleasant odors and appearance of a pet litter box to be removed from the home or dwelling and instead, segregated to a garage or other remote location. Further, in appropriate circumstances, the tunnel or hole through which the pet litter box may be accessed (i.e., aperture 12) may be cylindrical or circular in shape as a means of deterring dogs from entering the tunnel or hole while simultaneously encouraging cats to use the tunnel or hole. Further, the disclosed embodiments allow for the neat and orderly storage of accessories associated with pet litter boxes and pet waste disposal devices.

The embodiments disclosed herein prevent or minimize many of the problems associated with conventional pet litter boxes and other pet waste disposal devices, by removing the pet litter box or other pet waste disposal device from the main living area of a home or dwelling. Instead, the pet litter box or other pet waste disposal device is placed in an enclosed cabinet in the garage or other room and the pet gains access to the pet litter box or other pet waste disposal device thru a tunnel connecting the main living area to the remote pet litter box enclosure. As such, the disclosed embodiments can eliminate or greatly reduce the odor and dust from pet litter or other pet waste disposal device from getting inside the main living areas of the home or dwelling. Moreover, the present invention makes cleaning the pet litter box or other pet waste disposal device much easier and more sanitary than conventional devices.

While the foregoing written description of the present invention enables one of ordinary skill to make and use what the embodiments disclosed herein, those of ordinary skill will understand and appreciate the existence of variations, combinations and equivalents of the specific embodiment, method and examples herein. The present invention should therefore not be limited by the above described embodiment, method and examples, but by all embodiments and methods within the scope and spirit of the invention as claimed.

I claim:

1. A pet waste enclosure, comprising:
a rear wall, a left wall, a right wall, a top wall, a bottom wall, and a front wall;
wherein the rear wall, left wall, right wall, and bottom wall define an enclosure, the enclosure being able to house a pet waste disposal device;
wherein the rear wall includes an aperture, the aperture configured to allow access, by a pet, to the enclosure; and
the aperture further configured to receive a tunnel.

2. The pet waste enclosure of claim 1, wherein the front wall comprises at least one door, the at least one door being configured to allow access to the enclosure.

3. The pet waste enclosure of claim 1, wherein the top wall comprises at least one door, the at least one door being configured to allow access to the enclosure.

4. The pet waste enclosure of claim 1, further comprising a plurality of wheels coupled to the bottom wall.

5. The pet waste enclosure of claim 1, further comprising a hutch module coupled to the top wall.

6. The pet waste enclosure of claim 1, further comprising a tunnel coupled to the aperture.

7. The pet waste enclosure of claim 6, further comprising:
wherein the tunnel is configured to extend into a space, the space being separated by a distance from the rear wall; and
wherein the distance traverses at least two rooms of a building.

8. The pet waste enclosure of claim 1, wherein the pet waste disposal device is a litter box.

9. A pet litter box enclosure, comprising: an enclosed cabinet for housing a pet litter box, a tunnel for connecting the enclosed cabinet to the interior of a home or dwelling, and one or more doors or lids for allowing access to the interior of the cabinet and the pet litter box.

10. A pet waste disposal device enclosure, comprising: an enclosed cabinet for housing a pet waste disposal device, a tunnel for connecting the enclosed cabinet to the interior of a home or dwelling, and one or more doors or lids for allowing access to the interior of the cabinet and the pet waste disposal device.
